(19) United States
(12) Patent Application Publication
(10) Pub. No.: US 2014/0256379 A1
(43) Pub. Date: Sep. 11, 2014

(54) LENS HOLDING DEVICE

(71) Applicant: TDK Taiwan Corporation, Taipei City (TW)

(72) Inventors: Shang-Yu HSU, Taipei City (TW); Kun-Shih LIN, Taipei City (TW); Fu-Yuan WU, Taipei City (TW)

(73) Assignee: TDK Taiwan Corporation, Taipei City (TW)

(21) Appl. No.: 14/198,467

(22) Filed: Mar. 5, 2014

(30) Foreign Application Priority Data
Mar. 11, 2013 (JP) 2013-048278

(51) Int. Cl. H04M 1/02

(52) U.S. Cl. CPC H04M 1/0264
USPC 455/556.1

(57) ABSTRACT

A lens holding device comprising a lens carrier holding the lens; a base part supporting said carrier so that said carrier may make relative movement against said base part, a spring having a conductivity, resiliently connecting said base part and said lens carrier; and a connection terminal provided at said base part; wherein a housing groove is formed to said base part, said housing groove extending approximately perpendicular to an optical axis direction of said lens and having an opening at a side face of said base part, said side face extending in a direction approximately parallel to said optical axis direction, said connection terminal having a first end electrically connected with said spring, a second end opposite said first end, and a connection part resiliently housed in said housing groove connecting said first end and said second end by extending in a direction perpendicular to said optical axis direction.

### BACKGROUND OF THE INVENTION

1. Field of the Invention

The present invention relaxes to a lens holding device which is amiably used, for example, to camera module of the .mobile phone.

2. Background Art

For the leas holding device suitably which is used for camera module or so of the mobile phone, those having a function, which allows the relative movement of the lens carrier is proposed in order to carry oat the focusing movement or so.

Also, as for such lens holding devices, some of them may have connection terminals in order to supply the electricity for the relative movement of the lens carrier; and for purpose of the improving the efficiency or so of the assembling steps, it is proposed to improve the mounting embodiment of the connection terminal or so (refer to the patent document 1)

### PATENT DOCUMENTS

[Patent document 1] JP Patent Application Laid Open No. 2011-154120

### SUMMARY OF THE INVENTION

### The Problems to be Solved by the Invention

However, for the lens holding device according to the conventional arts, the step of fixing the connection terminal by heat welding was included before the step of securing the electrical connection between the connection terminal and other members; hence the assembling was time consuming and also the shape thereof was complicated.

The present invention is accomplished in view of such situation, and the object is to provide the lens holing device capable of securely and easily providing the connection terminal at a predetermined position, and with easy assembling.

### Means for Solving the Problem

In order to achieve the above mentioned objects the lens holding device according to the present invention comprises;

a lens holding device comprising

a lens carrier which holds the lens,

a base part supporting said lens carrier so that said lens carrier can make relative movement against said base part;

a spring having a conductivity and also resiliently connecting said base part and said lens carrier, and

a connection terminal provided at said base pan; wherein

a housing groove is formed to said base part and said housing groove is extending in a direction approximately perpendicular to au optical axis direction of said lens and having an opening at a side face of said base part, and said side face is extending in a direction approximately parallel to said optical axis direction, and

said connection terminal have

a first end part electrically connected with said spring,

a second end part which is an opposite end of said first end part, and

a connection part housed in said housing groove and connects said first end part and said second end part by extending in a direction perpendicular to said optical axis direction.

The lens holding device according to the present invention comprises the base part formed with the housing groove, the connection terminal having the connection, part housed in the base part. By having such shape for the housing groove and the connection terminal, the connection terminal is inserted by sliding along the housing groove from the side face aide of the base part, thereby the connection terminal can be easily and securely placed at the predetermined position. Also, the lens holding device according to the present invention allows easy assembling regarding the connection terminal.

Also, for example, said first end part and said second end part of said connection terminal may extend in a direction approximately parallel to said optical axis direction.

By extending the first end part in a direction approximately parallel to said optical axis direction, the electrical connection between the spring and the connection terminal can be easily secured; and by extending said second end part direction approximately parallel to the optical axis direction, the connection to the outer substrate of the connection terminal is easy.

Also, for example, said base part may have the spring providing face which extend in a direction approximately perpendicular to said optical axis direction, and that a part of said spring provided; and

said first end part may have the projection portion which projects out from said spring providing lace.

Such lens holding device easily ensures the electrical connection between the spring and the connection terminal by using the projection part.

Also, for example, a connecting groove may be formed to said base part which has the opening at said spring providing face and at said side face, and connects to said housing groove; and

said first end part may be inserted to said connecting groove.

As the connecting groove inserted with the first end part is formed at the base part, the connection terminal is securely held by said base part.

Also, for example, said spring may has the outer edge part which passes through between said projection part and said side face in the point of view from said optical axis direction; and said spring may be formed with through hole to which said projection part Is inserted.

During the step of ensuring the electrical con need on between said connection terminal and said spring, such lens holding device securely prevents said connection terminal from falling off from said base part.

Also, for example, said connection terminal is formed by bending the plank material, and

the extending direction of the face of said plank material is approximately parallel to said side face at said second end part; and said first end part and second end part may be approximately perpendicular with each other.

Such connection terminal has a simple shape, yet it can be placed in a small space, and thus allows the lens holding device to be farther compact.

Also, for example the lens holding device according to the present invention may comprise two connection terminals,

said housing grooves which houses each of said connection terminal may be formed to said base part in accordance with said connection terminals,

said lens carrier may be provided with a driving coil, and

said spring may have a first portion electrically connecting either one of said connection terminal and one and of said driving coil, and a second portion electrically connecting another one of said connection terminal and the other end of said driving coil, and said first portion and said second portion are insulated with respect to each other.

Such lens holing device can constitute the electricity supplying structure to the driving coil of the lens carrier by as embodiment with easy assembling, thus it has excellent productivity.

### BRIEF DESCRIPTION OF DRAWINGS

FIG. 1 is a prospective view of the lens holding device according to one embodiment of the present invention,

FIG. 2 is an exploded prospective view of the lens holding device shown in FIG. 1,

FIG. 3 is a perspective view showing the condition of a partial assembling of the B spring, bottom, and the connection terminal.

FIG. 4 is a side view showing the partial assembling of B spring, bottom, and the connection terminal.

FIG. 5 is a planar view showing the condition of a partial assembling of B spring, bottom, and the connection terminal.

FIG. 6 is an exploded perspective view for describing the steps of partial assembling of B spring, bottom, and the connection terminal.

FIG. 7 is a planar view showing the placement of the connection terminal with respect to the bottom.

FIG. 8 is an enlarged planar view describing that the electrical conductivity of the B spring and the connection terminal are secured,

FIG. 9 is a planar view of the plank material used for the production of the connection terminal.

### BEST MODE FOR CARRYING OUT THE INVENTION

The First Embodiment

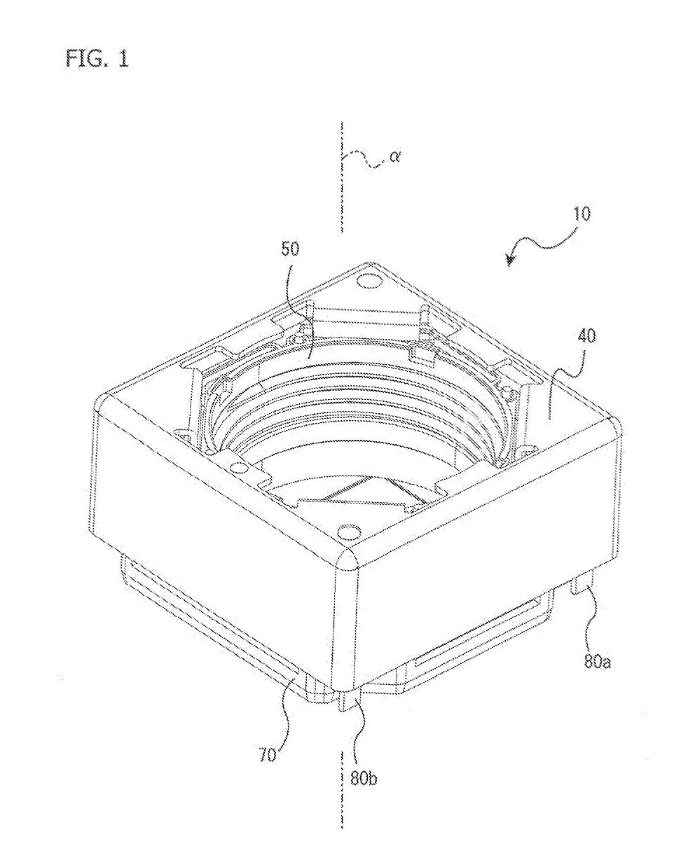

FIG. 1 is a perspective view of the lens holding device 10 according to an embodiment of the present invention. The lens holding device 10 has an outer shape of approximately a rectangular parallelpiped shape. At the center of the lefts holding device 10. the lens carrier 50 holding the lens, which is not shown in the figure, is placed; and at the outer peripheral side of the lens carrier 50, a yoke 40 and the bottom 70 as the base part are placed so that it surrounds the lens carrier 50.

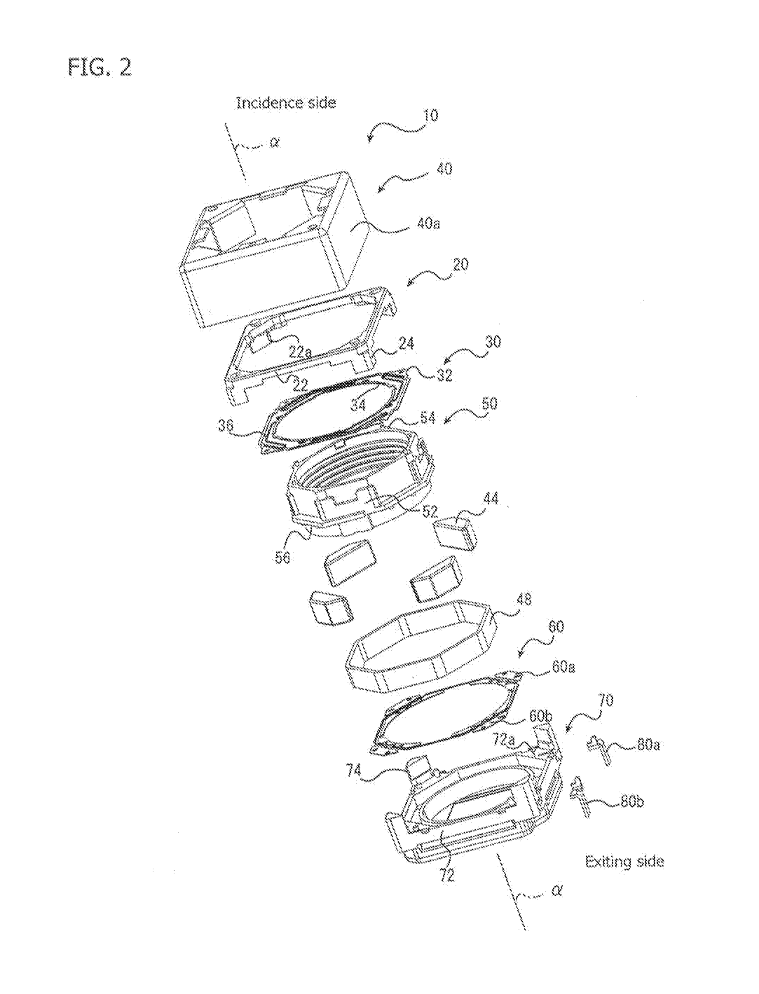

At the lens holding device 10, the cap 20 (refer to FIG. 2) and the bottom 70 holds the lens carrier 50, which holds the lens, so that the lens carrier 50 can make a relative movement freely against the cap 20 and the bottom 70. Also, as described in the following, at the inside of the less holding device 10, the voice coil motor is placed; and the lens holding device 10 allows the relative movement of the lens carrier 50 to the optical axis a direction with respect to the bottom 70 or so by the voice coil motor. The lens holding device 10 is used as a camera module or so with the focusing system by combining with the imaging element placed at the exiting side; however the purpose of use of the lens holding device 10 is not limited thereto.

FIG. 2 is an exploded perspective view of the lens holding device shown in FIG. 2. The lens holding device 10 comprises the yoke 40, the cap 20, the F spring 30, the lens carrier 50, the magnet 44, the coil 48, the B spring 60, the bottom 70, the connection terminal R 80a and the connection terminal L 80b. Note that, for explaining the lens holding device 10, the side of which the imaging light enters into the lens is defined as the incidence side, and the side where the imaging light which has entered outgoes is defined as the exiting side.

The yoke 40 is a member guiding the magnetic flux of the magnet 44 to the coil 48, and it is made of soft magnetic material such as iron or so. For the tens holding device 10 in the present embodiment, the yoke 40 has the outer peripheral part 40a which covers the outer peripheral of the cap 20 or the bottom 70, however the shape of the yoke 40 is not particularly limited, and it may be a shape which Is placed inside the cap 20 and the bottom 70. Also, the yoke 40 in the present embodiment is constituted by one member having a shape which appears approximately a rectangular parallelpiped shape; however it may be divided into plurality of members as the magnet 44.

The cap 20 supports the lens carrier 50 from the incidence side via the F spring 30. The cap 20 comprises the cap frame part 22 of a frame shape having a roughly a rectangular shape, and a cap column part 24 which projects out to the exiting side of the optical axis a direction from the four corners of the cap frame 22. At the end face of the exiting side of the cap frame part 22, the F spring providing face 22a is formed. The F spring providing face 22a extends in a direction approximately perpendicular to the optical axis a direction. At the F spring providing lace 22a, the outer ring part 32 of the F spring 30 is fixed by the adhesive agent or so. Also, the cap column part 24 of the cap 20 is connected to the bottom column 74 of the bottom 70 by the adhesive agent or so.

The F spring 30 shown in FIG. 2 resiliently connects the cap 20 and the lens carrier 50. The lens carrier 50 is supported, in a movable manner towards an optical axis a direction, against the bottom 70 to which the cap 20 is fixed via the F spring 50 and the B spring 60. The f spring 30 has a multi-stacked ring shape consisting of the outer ring part 32, the inner ring part 34 and the arm part 36.

The outer ring part 32 consisting the outer peripheral pan of the F spring 30 is fixed to the F spring providing face 22a of the cap frame part 22. The inner ring part 34 of the F spring 30 is placed at the inner peripheral side than the outer ring part 32, and it is fixed to the incidence side inner ring providing part 54 of the lens carrier 50 by the adhesive agent or so. The outer ring part 32 and the inner ring part 34 are connected by the arm part 36.

The F spring 30 is constituted by the resilient material of metal or so, and the arm part 36 can resiliently change the shape. By the arm part 36 changing the shape resiliently, the inner ring part 34 can make a relative movement towards the optical axis a direction with respect to the outer ring part 32.

The magnet 44 is provided in between the cap frame part 22 of the cap 20, and the bottom frame part 72 of the bottom 70. In the present embodiment, the magnet 44 is provided close to the inner peripheral of the column parts 24, 74 of the cap 20 and the bottom 70, and the magnet 44 is placed at four corners of the lens holding device 10; and when it is assembled, it faces the cod 48 attached to the lens carrier 50. The magnet 44 constitutes the voice coil motor fox driving the lens carrier 50 together with the yoke 40 and the coil 48.

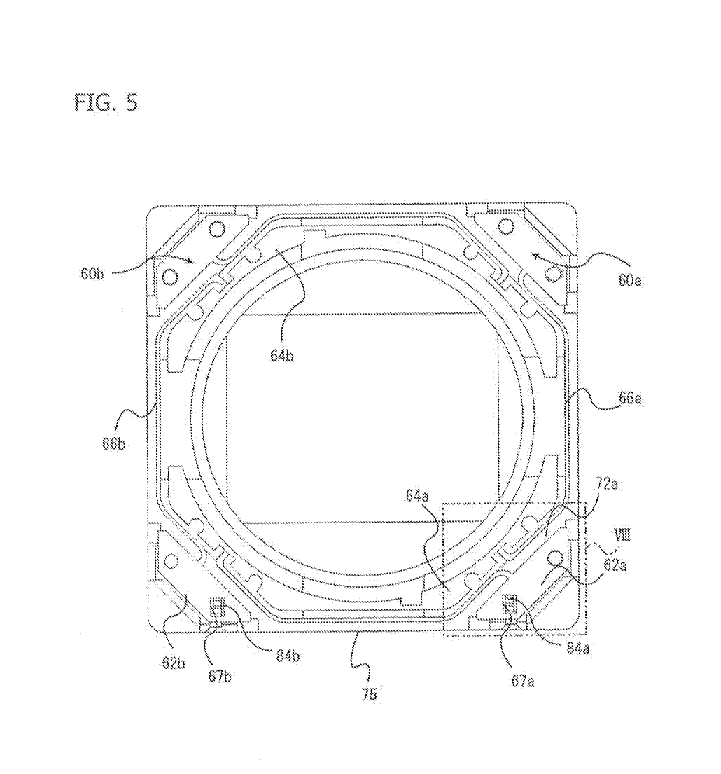

The coil 48 is fixed to the coil providing face 52 formed at the outer peripheral part of the lens carrier 50. Also, one end part of the winding coil constituting the coil 48 is electrically connected to the inner ring part R 64a (refer to FIG. 5) of the B spring R 60a, and other end part is electrically connected to the inner ring part L 64b (refer to FIG. 5) of the B spring L 60, Also, as shown in FIG. 5, the connection terminal: R 80a (the projection part R 84a is a part of the connection terminal R 80a) is electrically connected at the outer ring part 62a of the B spring R 60a; and the connection terminal L 80b (the projection part L 84b is a part of the connection terminal L 80b) is electrically connected at the outer ring part L 62b of the B spring L 60b. Therefore, at the coil 48 shown in FIG. 2, the electric power to drive the lens carrier 50 is supplied via the B spring R 60a. the B spring L 60b, and the connection terminals R 80a, L 80b connected thereto.

The lens carrier 50 has a cylindrical shape which is hallow and bottomless, and the lens (not shown in the figure) is fixed at the inner peripheral face of the lens carrier 50. At the end face of the incidence side of the lens carrier 50, the incidence side inner ring providing face 54 is formed; and at the incidence side inner ring providing part 54, the inner ring part 34 of the F spring 30 is fixed. On the other hand, at the end face of the exiting side of the lens carrier 50, the exiting side inner ring providing part 56 is formed, and the inner ring part R 64a and the inner ring part L 64b of the B spring 60 is fixed (refer to FIG. 5).

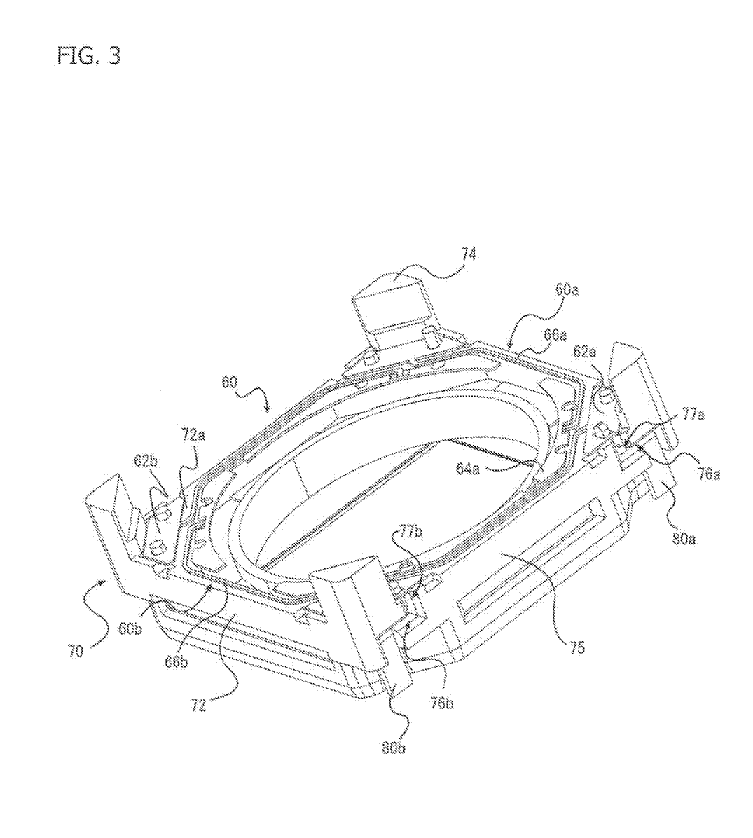

The B spring 60 shown in FIG. 2 resiliently connects the bottom 70 as the base part, and the lens carrier 50. The B spring 60 is constituted by two members which are separate and insulated against each other, that is by the B spring R 60a and the B spring L 60b; and it also functions as the wiring for supplying the electric power to the coil 48. The B spring 60 has a similar structure as the F spring 30 except that the two are separate; and as shown in FIG. 3, the B spring R 60a is made of the outer ring part R 62a, the inner ring part R 64a, the arm part R 66a, and the B spring L 60b is made of the outer ring part L 62b, the inner ring part L 64b, and the arm part L 60b.

As shown in FIG. 3, the outer ring part R 62a and the enter ring pan L 62b which constitutes the outer peripheral part of the B spring 60 is fixed to the B spring providing face 72a of the bottom frame part 72. The inner ring part R 64a and the inner ring part L 64b of the B spring 60 are placed at the inner peripheral side than the outer ring part R 62a and the enter ring part L 62b, and fixed at the exiting side inner ring providing part 56 of the lens carrier 50 (refer to FIG. 2) by the adhesive agent or so. The outer ring part R 62a and the inner ring part R 64a is connected by the arm part R 66a, and the outer ring part L 62b and the inner ring part L 64b are connected by the arm part L 66b.

The B spring 60 is constituted by the resilient material such as the metal or so as similar to the F spring 30, and the arm part R 66a and the arm part L 66b can be resiliently deformed. As the arm part R 66a and the arm part F 66b changing the shape resiliently, the inner ring part R 64a and the inner ring part L 64b can make a relative movement towards the optical axis o direction with respect to the outer ring part R 62a and the outer ring part L 62b.

The bottom 70 shown in FIG. 2 supports the tens carrier 50 so that a relative movement can be made, via the B spring 60 and the F spring 30 which is connected via the cap 20. A through hole is formed at the center part of the bottom 70, and the bottom 70 comprises the bottom frame part 72 having an outer peripheral shape which is roughly a rectangular shape from view point of the optical axis a direction, and the bottom column part 74 which projects out to the incidence side of the optical axis a direction from the four corners of the bottom frame part 72. The bottom 70 has the B spring providing face 72a at the end face of the incidence side of the bottom frame part 72. The B spring providing face 72a. extends in a direction approximately perpendicular to the optical axis a direction, and the outer ring part R 62a and the outer ring part L 62b of the B spring 60 (refer to FIG. 5).

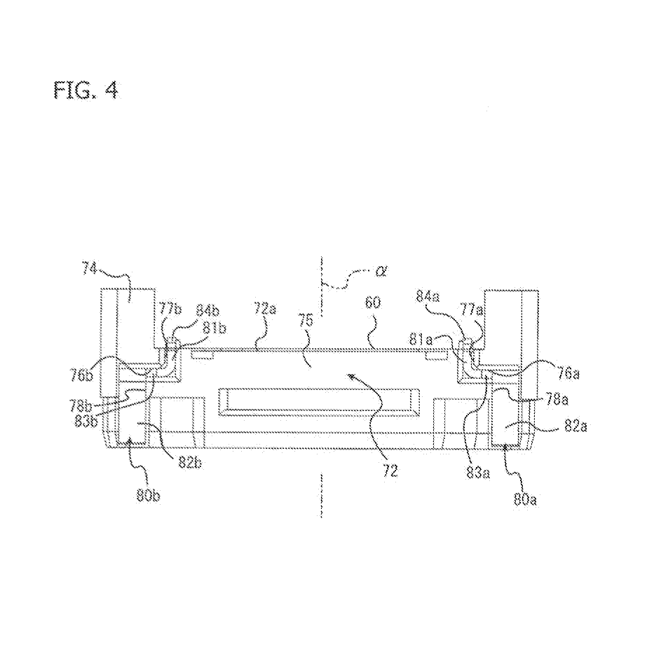

As shown in FIG. 3 and FIG. 4, the bottom frame part 72 has four outer peripheral side faces which extends to the direction approximately parallel to the optical axis a direction; and at the side face 75 which is one of the four outer peripheral side faces, the grooves or so for assembling and providing the connection terminal R 80a and the connection terminal L 80b are formed. That is, at the aide face 75, the housing groove R 76a for providing the connection terminal R 80a, the connecting groove R 77a and the notch R 78a, die housing groove L 76b for providing the connection terminal L 80b, the connecting groove L 77b and the notch L 78b are formed.

The housing groove R 76a and the housing groove L 76b has an opening at the side face 75, and extends in a direction approximately perpendicular to the optical axis a direction, further houses the face which extends in a direction approximately perpendicular to the optical axis a direction. Note that, the housing groove R 76a and the housing groove L 76b extends in a direction approximately perpendicular to the optical axis a direction, this means that these extends along the direction approximately perpendicular to the optical axis a direction and has a pair of a wall part which faces against each other.

The connecting groove R 77a and the connecting groove L 77b has an opening at the B spring providing face 72a and the side face 75. Also, the connecting groove R. 77a connects to the housing groove R 76a; and the connecting groove L 77b connects to the housing groove L 76b. The connecting groove R 77a and the connecting groove L 77b extends in a direction approximately parallel to the optical axis α direction; and houses the face extending m a direction approximately parallel to the optical axis α direction. Note that, the connecting groove R 77a and L 77b extends In a direction approximately parallel to the optical axis a direction means that the connecting groove R 77a and L 77b comprises a pair of wail part which faces against each other by extending along the direction approximately parallel to the optical axis a direction.

The notch R 78a has a shape wherein a part of the wall at the exiting side of the groove continuing to the housing groove R 76a is cut out, and the second end part R 82a of the second connection terminal R 80a can be released to the exiting side. Also, the notch L 78b has a shape wherein a part of the wall at the exiting side of the groove continuing to the housing groove L 76a is cut out. and the second end part L 80b of the second connection terminal L 82b can be released to the exiting side.

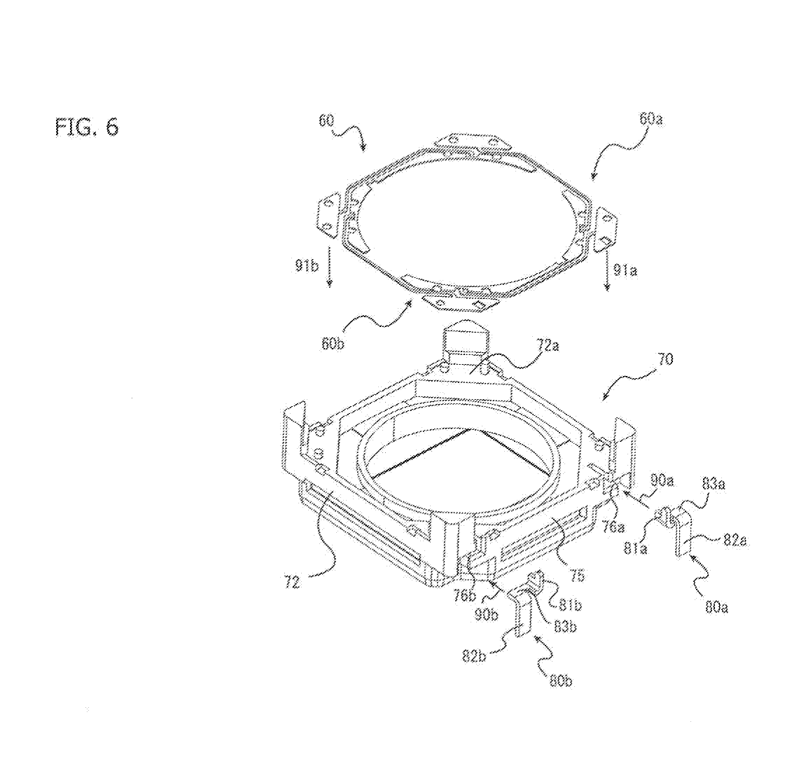

As shown in FIG. 6, the connection terminal R 80a has the first end part R 81a which electrically connects the B spring R 60a extending in a direction approximately parallel to the optical axis a direction; the second end part. R 82a which is an end part of the opposite side of the first end part R 81a; and the connection part R 83a which connects the first end part R 81a and the second end part R 82a. The first end part R 81a and the second end part R 82a extends in a direction approximately parallel to the optical axis α direction, and the connection part R 83a extends in a direction approximately perpendicular to the optical axis a direction.

As shown in FIG. 4, the connection part R 83a of the connection terminal R 80a is housed in the housing groove R 76a of the bottom 70. The first end part R 81a is inserted in the connecting groove R 77a of the bottom 70, and a part thereof projects out to the incidence side from the B spring providing face 72a and the B spring R 60a. That is, the first end part R 81a has the projection part R 84a which projects out from the B spring providing face 72a. Also, the second cod part R 82a passes through the notch R 78a.

As shown in FIG. 6, the connection terminal L 80b comprises, as similar to the connection terminal R 80a, the first end part L 81b electrically connecting with the B spring L 60b by extending in a direction approximately parallel to the optical axis a direction; the second end part L 82b which is the end part opposite of the first end part L 81b, and the connection part L 83b which connects the first end part L 81b; and the second end part L 82b. The first end part L 81b and the second end part L 82b extends in a direction approximately parallel to the optical axis a direction; and the connecting part L 83b extends in a direction approximately perpendicular to the optical axis a direction.

The connection terminal L 80b is symmetrically placed with respect to the connection terminal R 80a. That is, as shown in FIG. 4, the connection part L 83b of the connection terminal L 80b is housed in the housing groove L 76b of the bottom 70; and the first end part L 81b is inserted in the connecting groove L 77b of the bottom 70, further the projection part L 84b which is a part of the first end part L 81b projects out to the incidence side form the B spring providing face 72a and the B spring L 60b, Also, the second end part L 82b is inserted in the notch L 78b.

The connection terminal R 80a and the connection terminal L 80b functions as the electricity supplying terminal for supplying the electric power to the voice coil motor of the lens holing device 10 from the outside. Therefore, the second end part R 82a and the second end part L 82b are electrically connected against the exterior substrate or so which is not shown in the figure.

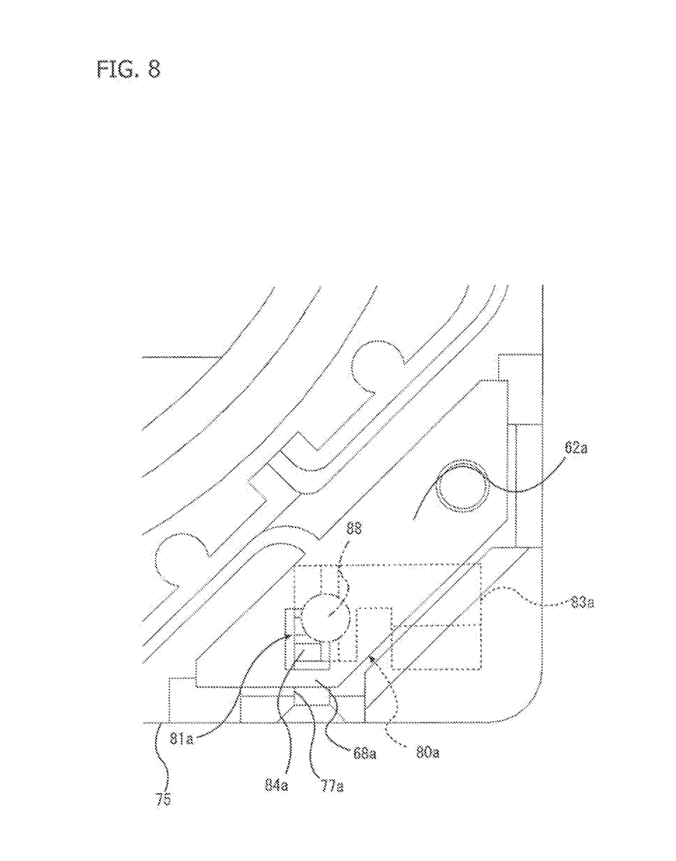

By using FIG. 6 and FIG. 8, the assembling method of the connection terminal R 80a of the bottom 70, the connection terminal L 80b and the B spring 60 will be described, in FIG. 6, as shown by the arrow 90a and the arrow 90b, the connection terminal R 80a and the connection terminal L 80b are assembled against the bottom 70. The connection terminal R 80a and the connection terminal L 80b are installed to the bottom 70 from the side face 75 side, so shat the connection part R 83a and the connection pan L 83b are housed in the housing groove R 76a and the housing groove L 76b respectively.

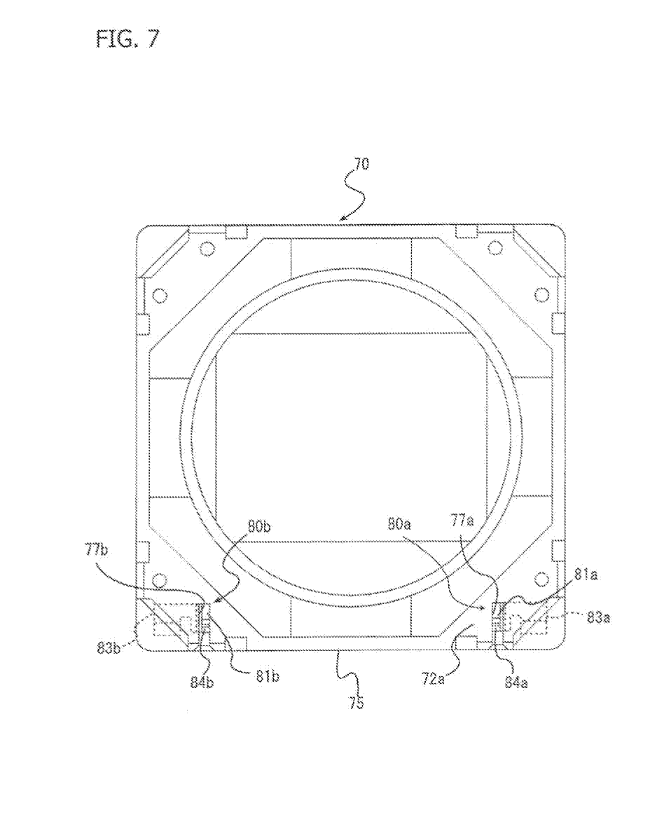

As shown in FIG. 7, the connecting groove R 77a and the connecting groove L 77b which are inserted by the first end part R 81a and the first end part L 81b has an opening at the B spring providing face 72a and the side face 75. Therefore, also the first end part R 81a and the first end part L 81b can enter into the connecting groove R 77a and the connecting groove L 77b from the side face 75 side, when the connection part R 83a and the connection part L 83b eaters into the housing groove R 76a and the housing groove L 76b. Similarly, the second end part R 82a and the second end part L 82b shown in FIG. 6 and FIG. 7 can enter into the notch R 78a and the notch L 78b (refer to FIG. 4).

As shown in FIG. 7, under the condition that the connection terminal R 80a and the connection terminal L 80b are assembled against the bottom 70, the projection part R 84a of the first end part R 81a and the projection part L 84b of the first end part L 81b projects out from the B spring providing face 72a. To the bottom 70 which is assembled with the connection terminal R 80a and the connection terminal L 80b, as shown by the arrow 91a and the arrow 91b of FIG. 6, the B spring R 60a and the B spring L 60b are placed at the B spring providing face 72a.

FIG. 5 shows the condition wherein the connection terminal R 80a, the connection terminal L 80b, the B spring R 60a, and the B spring L 60b are placed against the bottom 70. The through hole R 67a is formed at the outer ring part R 62a of the B spring R 60a, and the through hole L 67b is formed at the outer ring part L 62b of the B spring L 60b. The projection part R 84a and the projection part L 84b which projects oat from the B spring providing face 72a are inserted in the corresponding through hole R 67a and the through hole L 67b.

As shown in FIG. 8 which has enlarged view of the area near the projection part R 84, the outer edge part R 68a of the outer ring part L 62b (a part of the B spring R 60a) passes through between the projection part R 84a and the side face 75 of the bottom 70, from the point of view of the optical axis α direction. The outer edge part R 68a covers a part of the opening of the connecting groove R 77a to limit the movement of the first end part R 81a; thereby it prevents the connection terminal R 80a from, falling off while the soldering step which will he described in the following is completed.

After placing the connection terminal R 80a, the connection terminal L 80b and the B spring 60 against the bottom 70, the electrical conductivity of the connection terminal R 80a, the connection terminal L 80b, the B spring R 60a, and the B spring L 60b are secured. The example shown in FIG. 8, the solidified part 88 is formed by solidifying the solder so that it extends over the first end part R 81a (preferably including the projection part R 84a) and the outer ring part R 62a. Also for the first end part L 81b and the outer ring part L 62b, the solidified part 88 is formed by solder as similar to FIG. 8.

As described hereinabove, for the lens holding device according to the present embodiment, the connection terminal R 80a, the connection terminal L 80b and the B spring 60 are assembled against the bottom 70.

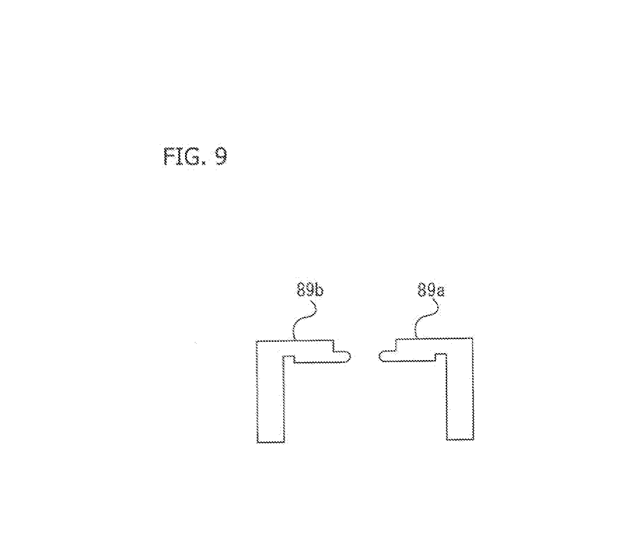

Note that, the production method of the connection terminal R 80a and the connection terminal L 80b shown in FIG. 6 is not particularly limited, and for example. It may be made by bending the plank materials 89a. 89b made of metal as shown in FIG. 9. In this ease, the extending direction of the plank materials 89a and 89b is parallel to the side face 75 at the second end part R 82a and the second end part L 82b as shown in FIG. 6; and the first end part R 81a and the first end part L 81b, and the second end part R 82a and the second end part L 82b are perpendicular with respect to each other.

Such connection terminal R 80a and the connection terminal L 80b has a simple shape, yet it is possible to be placed at a small space of the bottom 70; thus it contributes to make the lens holding device 10 further compact.

As shown in FIG. 6, in the lens holding device 10, the connection part R 83a of the connection terminal R 80a and the connection part L 83b of the connection terminal L 80b inserted while sliding along the housing groove R 76a and the housing groove L 76b from the side face 75 side of the bottom 70; thereby it can be placed easily and securely at the predetermined position.

The first end part R 81a and the first end part L 81b extends towards the exiting side which is the direction approximately parallel to the optical axis a direction from the end part of the connection part R 83a or the connection part L 83b. Thereby, the tip of the first end part R 81b and the first end part L 81b approaches to the B spring providing face 72a, or it projects aid from the B spring providing face 72a; hence the electrical conductivity with the B spring 60 placed at the B spring providing face 72a is easily secured.

Also, at the bottom 70, the connecting groove R 77a, the connecting groove L 77b are formed; and the first end part R 81a and the first end part L 81b are inserted, in the connecting groove R 77a and the connecting groove L 77b. Thereby, the connection terminal R 80a and the connection terminal L 80b can be assembled at the predetermined position further accurately, and also it is held by the bottom 70 further securely.

Other Embodiment

Such lens holding device 10 may be used as the optical device having a focusing mechanism and a blur correction mechanism by combining with voice coil motor which moves to the direction perpendicular to the optical, axis a direction. Also, the method for securing the conductivity of the connection, terminal R 80a, the connection terminal L 80b with B spring R 60a and the B spring L 60b is not particularly limited to the solder, and the method of using the conductive adhesive agent, and the welding or caulking or so may be used to ensure the conductivity. Also, different from the example shown in FIG. 6, the B spring R 60a and the B spring L 60b, and the connection terminal R 80a and the connection terminal L 80b may be made as one body against the bottom 70 when being assembled, and it only needs to be separated insulated by the time the voice coil motor is driven.

### NUMERICAL REFERENCES

10 . . . Lens holding device

12 . . . Cover

20 . . . Cap

22 . . . Cap frame part

22a . . . F spring providing face

24 . . . Cap column part

30 . . . F spring

32 . . . Outer ring part

34 . . . Inner ring part

36 . . . Arm part

40 . . . Yoke

40a . . . Outer peripheral part

44 . . . Magnet

48 . . . Coil

50 . . . Lens earner

52 . . . Coil providing part

54 . . . Incidence side inner ring providing part

56 . . . Exiting side inner ring providing part

60 . . . B spring

60a. . . . B spring R

40b . . . B spring L

62a, 62b . . . Outer nag part

64a. 64b . . . Inner ring part

66a, 66b . . . Arm part

67a, 66b . . . Through hole

68a . . . Outer edge part

70 . . . Bottom

72 . . . Bottom frame part

72a . . . B spring providing face

74 . . . Bottom column part

75 . . . Side face

76a, 76b . . . Housing groove

77a, 77b . . . Connecting groove

78a, 78b . . . Notch

80a, 80b . . . Connection terminal

81a. 81b . . . First end part

82a, 82b . . . Second end part

83a, 83b . . . Connection part

84a, 84b . . . Projection part

88 . . . solder

1. A lens holding device comprising:
a lens carrier which holds the lens,
a base part supporting said lens carrier so that said lens carrier can make relative movement against said base part,
a spring having a conductivity and also resiliency connecting said base part and said lens carrier, and
a connection terminal provided at said base part; wherein
a housing groove is formed to said base part and said housing groove is extending in a direction approximately perpendicular to an optical axis direction of said lens and having an opening at a side face of said base part, and said side face is extending in a direction approximately parallel to said optical axis direction, and
said connection terminal have
a first end part electrically connected with said spring,
a second end part which is an opposite end of said first end part, and
a connection part housed in said housing groove and connects said first end part and said second end part by extending in a direction perpendicular to said optical axis direction.

2. The lens holding device as set forth in claim 1, wherein said first end part and said second end part of said connection terminal are extending in a direction approximately parallel to said optical axis direction.

3. The lens holding device as set forth in claim 1, wherein said base part has a spring providing face extending in a direction approximately perpendicular to said optical axis direction and a part of said spring is provided, and
said first end part has a projection part which projects out from said spring providing face.

4. The lens holding device as set forth in claim 3, wherein a connecting groove is formed to said base part and said connecting groove has an opening at said spring providing face and said side face and said connecting groove connects to said housing groove, and
said first end part passes through said connecting groove.

5. The lens holding device as set forth in claim 3, wherein said spring has an outer edge part passing between said projection part and said side face in view from said optical axis direction.

6. The lens holding device as set forth in any one of claims 3, wherein a through hole which allows said projection part to be inserted is formed at said spring.

7. The lens holding device as set forth in claim 1, wherein said connection terminal is formed by bending a plank material, and
an extending direction of said plank material is approximately parallel to said side face at said second end part, and
said extending direction of said plank material at said first end part and said extending direction of said plank material at said second end part are approximately perpendicular with respect to each other.

8. The tens holding device as set forth in claim 1, comprising two said connection terminals,
said housing grooves which houses each of said connection terminal are formed to said base part in accordance with said connection terminals,
said lens carrier is provided with a driving coil, and
said spring has a first portion electrically connecting either one of said connection terminal and one end of said driving coil, and a second portion electrically connecting another one of said connection terminal and the other end of said driving coil, and said first portion and said second portion are insulated with respect to each other.
